(19) United States
(12) Patent Application Publication
(10) Pub. No.: US 2008/0006358 A1
(43) Pub. Date: Jan. 10, 2008

(54) Wheel rim, in particular for an all-terrain vehicle or running at low pressure

(76) Inventors: Gerard Tavin, Montargis (FR); Victor Zarife, Cepoy (FR)

Correspondence Address: CLARK & BRODY, 1090 VERMONT AVENUE, NW, SUITE 250, WASHINGTON, DC, 20005, US

(21) Appl. No.: 11/481,835

(22) Filed: Jul. 7, 2006

(51) Int. Cl. B60C 19/00

(52) U.S. Cl. 152/513; 152/375

(57) ABSTRACT

A wheel rim, in particular for an all-terrain vehicle or a vehicle that is to run at low pressure, the rim including an anti-abrasion coating in at least one sensitive zone situated between the rim and the beads of a tire that is to be mounted on the rim, wherein the coating presents at least one sealing lip suitable for opposing penetration of abrasion particles between the rim and the beads of the tire.

The invention relates to a wheel rim designed more particularly for a vehicle that is to run on uneven terrain, tracks, or the like, or that is to run at low pressure.

### BACKGROUND OF THE INVENTION

In general, a wheel rim presents two peripheral flanges against which the two beads of the tire come to bear, it being necessary for the bearing force to be sufficient to obtain a good coefficient of friction between the rim and the tire, thus ensuring proper drive when the vehicle is running in particular at low pressure on soft terrain, for example.

The contact zones between the rim and the tire beads are sensitive and can be damaged by solid particles from the external environment penetrating into said contact zones and leading to wear that is liable to harm the coefficient of friction between the rim and the tire, and can lead to a premature change of the tire and/or of the rim.

To mitigate those risks of wear, it is known to apply surface hardening to the aluminum when the rim is made of that material.

### OBJECTS AND SUMMARY OF THE INVENTION

An object of the invention is to propose a novel solution to the problem of potential abrasion of the contact surfaces between a wheel rim and tire beads in order to mitigate the above-mentioned prior-art solution.

To this end, the invention proposes a wheel rim, in particular for an all-terrain vehicle or a vehicle that is to run at low pressure, which rim includes an anti-abrasion coating in at least one sensitive zone situated between the rim and the beads of a tire that is to be mounted on the rim, wherein said coating presents at least one sealing lip suitable for opposing penetration of abrasive particles between the rim and the tire beads.

Advantageously, said coating is made of an elastomer material, the anti-abrasion coating possibly being made of polyurethane presenting thickness of millimeter order, for example.

In general, the rim may be made of aluminum, and it can comprise a single piece or be made of at least two pieces.

The invention also provides a wheel having such a rim.

The rim of the invention together with its anti-abrasion coating presents an important advantage, that of increasing the coefficient of friction between the rim and the tire beads. This makes it possible either to omit the annular piece of packing known as a “beadlock” for maintaining driving force on the tire from the rim when running at low pressure, or else to reduce the weight of the beadlock. In addition, if the beadlock is omitted, it is possible to use a rim comprising a single piece instead of two as is the practice when a beadlock is necessary.

Furthermore, the lack of wear, both on the tire beads and on the rim, makes it possible to avoid premature change of one and/or both of these elements, which constitutes a result that is advantageous from a financial point of view for the owner of the vehicle.

### BRIEF DESCRIPTION OF THE DRAWINGS

Other advantages, characteristics, and details of the invention appear from the additional description below given with reference to the accompanying drawing that is given purely by way of example and in which:

FIG. 1 is a half-view in section of a wheel rim of the invention;

FIG. 2 is a half-view in section of the FIG. 1 wheel rim with two tire beads mounted on the rim; and

FIG. 3 is an enlargement of detail III of FIG. 2.

### MORE DETAILED DESCRIPTION

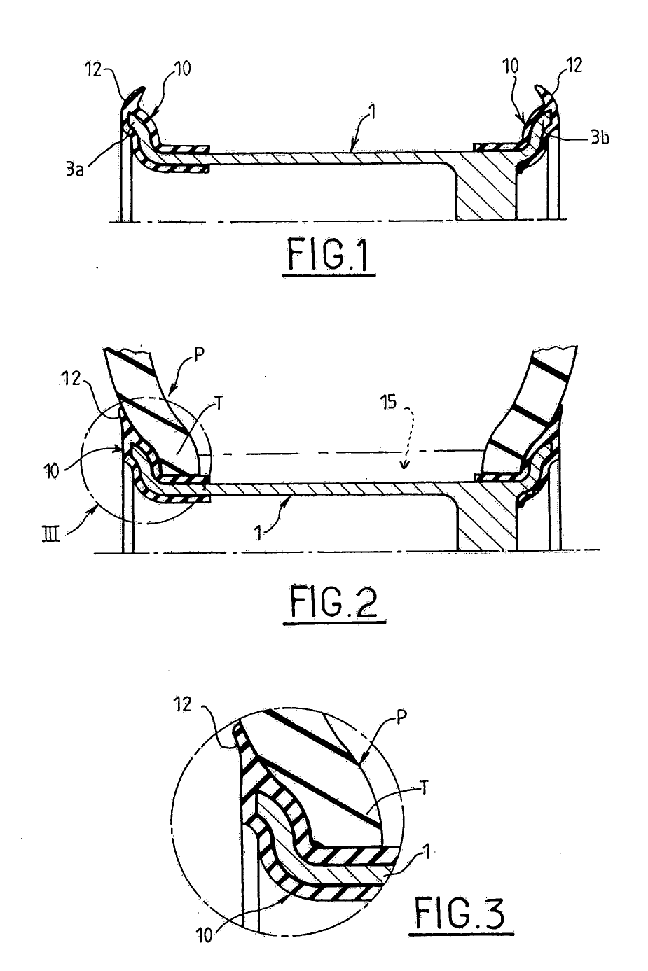

The wheel rim 1 is a one-piece rim, for example, which in conventional manner presents two peripheral flanges 3a and 3b (FIG. 1) with the two beads T of a tire P (FIG. 2) coming to bear against the inside faces of the flanges.

At least the two flanges 3a and 3b of the rim are covered in an anti-abrasion coating 10 of elastomer material, such as polyurethane for example, having thickness of millimeter order. It is also possible to provide the presence of at least one sealing lip 12 extending generally from the tip of each flange 3a or 3b (FIG. 1), and serving, once deformed, to come into tight contact with a bead T of the tire P (FIGS. 2 and 3).

In general, when the rim 1 is made of aluminum and obtained by a casting method, experience shows that it can present porosity defects. Under such circumstances, the anti-abrasion coating 10 may be deposited over the entire surface of the rim 1 so as to mitigate such porosity defects.

Furthermore, it is known with two-piece rims to mount a piece of annular packing 15 known as a “beadlock” around the rim, and as shown in chain-dotted lines in FIG. 2, for the purpose of pressing the beads of the tire P against the two flanges 3a and 3b of the rim so as to provide better drive of the tire P by the rim 1. In general, this beadlock 15 is a part made of metal and/or of rubber and it increases the weight of the rim considerably and makes it necessary for the rim to comprise at least two pieces. Experience shows that the anti-abrasion coating 10 increases the coefficient of friction between the rim and the tire bead, thereby making it possible to omit the beadlock 15, or at least to reduce its weight. This concept of weight is important, particularly for military vehicles that need to be transported by air.

The anti-abrasion coating 10 can be deposited by spraying or by molding, and it is held securely in place by conventional bonding agents. The anti-abrasion coating and its sealing lip 12 constitute a single piece, it being understood that it might optionally be made by extrusion using two different materials.

The tire P mounted on the rim 1 is advantageously a tubeless tire, and it may also be fitted with a run-flat system.

What is claimed is:

1. A wheel rim, in particular for an all-terrain vehicle or a vehicle that is to run at low pressure, the rim including an anti-abrasion coating in at least one sensitive zone situated between the rim and the beads of a tire that is to be mounted on the rim, wherein the coating presents at least one sealing lip suitable for opposing penetration of abrasion particles between the rim and the beads of the tire.

2. A wheel rim according to claim 1, in which the coating is made of an elastomer material.

3. A wheel rim according to claim 2, in which the coating is made of polyurethane.

4. A wheel rim according to claim 1, in which the coating presents thickness of millimeter order.

5. A wheel rim according to claim 1, in which the coating is sprayed or molded on the rim.

6. A wheel rim according to claim 1, in which the rim is made of aluminum.

7. A wheel rim according to claim 1, in which the rim comprises a single piece.

8. A wheel rim according to claim 1, in which the rim is made up of at least two pieces.

9. A wheel rim according to claim 8, in which a piece of annular packing is fitted around the rim to bear against the two beads of the tire, said piece of packing being reduced in weight.

10. A wheel for an all-terrain vehicle or for running at low pressure, the wheel comprising a tire mounted on a rim, wherein the rim is a rim according to claim 1.
